(19) United States
(12) Patent Application Publication
(10) Pub. No.: US 2016/0323716 A1
(43) Pub. Date: Nov. 3, 2016

(54) POSITIONING METHOD AND POSITIONING SERVER

(71) Applicants: BOE TECHNOLOGY GROUP CO., LTD., Beijing (CN); ORDOS YUANSHENG OPTOELECTRONICS CO., LTD., Ordos (CN)

(72) Inventors: Chenjuan LI, Beijing (CN); Zhaohui MENG, Beijing (CN); Lina LIU, Beijing (CN)

(73) Assignees: BOE TECHNOLOGY GROUP CO., LTD., Beijing (CN); ORDOS YUANSHENG OPTOELECTRONICS CO., LTD., Ordos (CN)

(21) Appl. No.: 15/142,674

(22) Filed: Apr. 29, 2016

(30) Foreign Application Priority Data
Apr. 29, 2015 (CN) 201510213714.5

(51) Int. Cl. H04W 4/04; G06F 17/30; G06T 7/00; H04W 4/02; G06K 9/62; G06K 9/00

(52) U.S. Cl. CPC H04W 4/04; G06K 9/6215; G06K 9/00664; G06K 9/00637; G06T 7/0044; H04W 4/025; G06F 17/30241; G06F 17/30268; G06T 2207/30184

(57) ABSTRACT

A positioning method and a positioning server are provided. The positioning method includes: receiving a surrounding real image at a location of a requesting user from the requesting user; comparing the surrounding real image with prestored images in a map database, each prestored image corresponding to one piece of location point information; obtaining a prestored image matching the surrounding real image and location point information corresponding to the prestored image; generating site location information of the requesting user based on the obtained location point information; and sending the site location information to a target user.

### CROSS-REFERENCE TO RELATED APPLICATION

The present application claims a priority to Chinese Patent Application No. 201510213714.5 filed on Apr. 29, 2015, the disclosure of which is incorporated in its entirety by reference herein.

### FIELD

The present disclosure relates to the field of positioning technology, and in particular, to a positioning method and a positioning server.

### BACKGROUND

Global positioning system (GPS) positioning technology is mainly used for positioning the location of a user and transmitting positioning information. The positioning principle is described as follows. A mobile terminal firstly performs GPS positioning, and transmits longitude and latitude information to a positioning server once the GPS positioning is accomplished. The positioning server marks the location of the mobile terminal on a map based on the longitude and latitude information, and then responds with a web link of the map to the mobile terminal. Finally, the current location of the mobile terminal on the map may be displayed on a webpage opened by the mobile terminal.

Each piece of longitude and latitude information covers a certain range, and if two users are located in the range covered by one piece of longitude and latitude information, they may obtain same longitude and latitude information through GPS positioning. However, modern city is heavily built-up with various buildings such as skyscrapers, shopping malls and flyovers, once two users are separated by a building, they can hardly find each other using positing function of their cellphones even if they are within the range covered by same piece of longitude and latitude information.

How to realize accurate positioning for two or more users which are close to each other is always a problem to be solved by those skilled in the art.

### SUMMARY

In view of the above, a positioning method and a positioning server are provided in the present disclosure, with which accurate positioning for two or more users which are close to each other can be realized.

Considering the above technical problem, the present disclosure provides a positioning method, including: receiving a surrounding real image at a location of a requesting user sent by the requesting user; comparing the surrounding real image with prestored images in a map database, where each prestored image corresponds to one piece of location point information; obtaining a prestored image matching the surrounding real image and location point information corresponding to the prestored image; generating site location information of the requesting user based on the obtained location point information; and sending the site location information to a target user.

Optionally, the positioning method may further include: receiving geographical location information of the location of the requesting user sent by the requesting user. The step of comparing the surrounding real image with prestored images in a map database may include: obtaining, from the map database, a prestored image corresponding to the geographical location information; and comparing the surrounding real image with the prestored image corresponding to the geographical location information.

Optionally, the requesting user may include a first user and a second user. The step of obtaining a prestored image matching the surrounding real image and location point information corresponding to the prestored image may include: obtaining first location point information corresponding to a prestored image matching the surrounding real image sent by the first user and second location point information corresponding to a prestored image matching the surrounding real image sent by the second user. The step of generating site location information of the requesting user based on the obtained location point information may include: generating site location information including a relative location relationship between the first user and the second user based on the first location point information and the second location point information.

Optionally, the site location information may include information of a route between locations of the first user and the second user.

Optionally, the surrounding real image and each prestored image may both include information of a building.

Optionally, the location point information may include orientation information of a building in the prestored image.

Optionally, the site location information may include information of a location of the user with respect to the building generated based on the orientation information of the building.

Optionally, the map database may include a local map database and map databases in other servers. The step of comparing the surrounding real image with prestored images in a map database may include: comparing the surrounding real image with prestored images in the local map database; and in response to failure in finding a prestored image matching the surrounding real image in the local map database, inquiring the map databases in other servers through network to determine whether any of the map databases stores a prestored image matching the surrounding real image.

Optionally, the target user is the requesting user.

Optionally, the target user is a user other than the requesting user. Before the step of sending the site location information to a target user, the positioning method may include: receiving information about the target user sent by the requesting user.

The present disclosure further provides a positioning server, including: a receiving unit, adapted to receive a surrounding real image at a location of a requesting user sent by the requesting user; a comparing unit, adapted to compare the surrounding real image with prestored images in a map database, where each prestored image corresponds to one piece of location point information; an obtaining unit, adapted to obtain a prestored image matching the surrounding real image and location point information corresponding to the prestored image; a generating unit, adapted to generate site location information of the requesting user based on the obtained location point information; and a sending unit, adapted to send the site location information to a target user.

Optionally, the receiving unit is adapted to receive geographical location information of the location of the requesting user sent by the requesting user. and the comparing unit is adapted to obtain, from the map database, a prestored image corresponding to the geographical location information; and compare the surrounding real image with the prestored image corresponding to the geographical location information.

Optionally, the requesting user includes a first user and a second user. The generating unit is adapted to: obtain first location point information corresponding to a prestored image matching the surrounding real image sent by the first user and second location point information corresponding to a prestored image matching the surrounding real image sent by the second user; and generate site location information including a relative location relationship between the first user and the second user based on the first location point information and the second location point information.

Optionally, the map database includes a local map database and map databases in other servers. The comparing unit is adapted to: compare the surrounding real image with prestored images in the local map database; and in response to failure in finding a prestored image matching the surrounding real image in the local map database, inquire the map databases in other servers through network to determine whether any of the map databases stores a prestored image matching the surrounding real image.

Optionally, the target user is the requesting user.

Optionally, the target user is a user other than the requesting user. The receiving unit is adapted to receive information about the target user sent by the requesting user.

The above technical solutions of the present disclosure lead to the following beneficial effects. The positioning server prestores an image of a predetermined location and location point information of the predetermined location in the image. In response to reception of the surrounding real image captured by the requesting user in real time, the positioning server obtains a prestored image matching the surrounding real image and location point information corresponding to the prestored image, thereby determining the location of the requesting user. The positioning server sends the location information of the requesting user to the target receiver, e.g., another user, thereby realizing accurate positioning for two or more users which are close to each other.

### BRIEF DESCRIPTION OF THE DRAWINGS

FIG. 1 is a schematic diagram of a positioning method of a user in a related art;

FIG. 2 is a schematic flowchart of a positioning method according to at least one embodiment of the present disclosure;

FIG. 3 is a schematic diagram of site location information according to at least one embodiment of the present disclosure;

FIG. 4 is another schematic flowchart of a positioning method according to at least one embodiment of the present disclosure;

FIG. 5 is another schematic diagram of site location information according to at least one embodiment of the present disclosure;

FIG. 6 is further another schematic diagram of site location information according to at least one embodiment of the present disclosure; and

FIG. 7 is a structure diagram of a positioning server according to at least one embodiment of the present disclosure.

### DETAILED DESCRIPTION OF THE EMBODIMENTS

Specific implementations of the present disclosure are detailed in conjunction with the drawings and embodiments. The following described embodiments are intended to explain, rather than limit, the present disclosure.

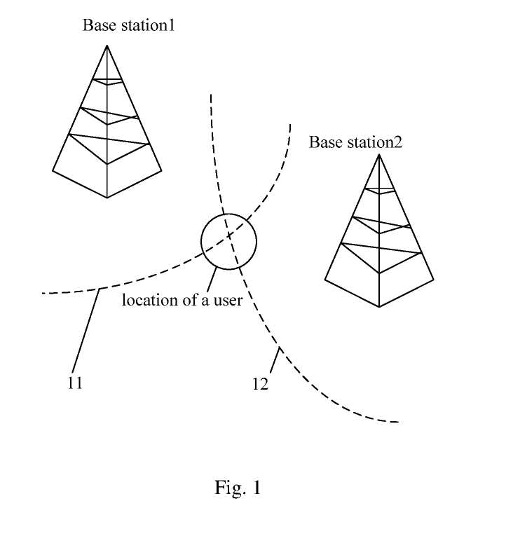

Usually, two or three base stations are required in a positioning method in the related technology. As shown in FIG. 1, a base station 1 determines location information of a user through communication with the user, and positioning performed by the base station 1 is represented by a curve 11. A base station 2 determines location information of the user through communication with the user, and positioning performed by the base station 2 is represented by a curve 12. The intersection of curves 11 and 12 represents current location information of the user.

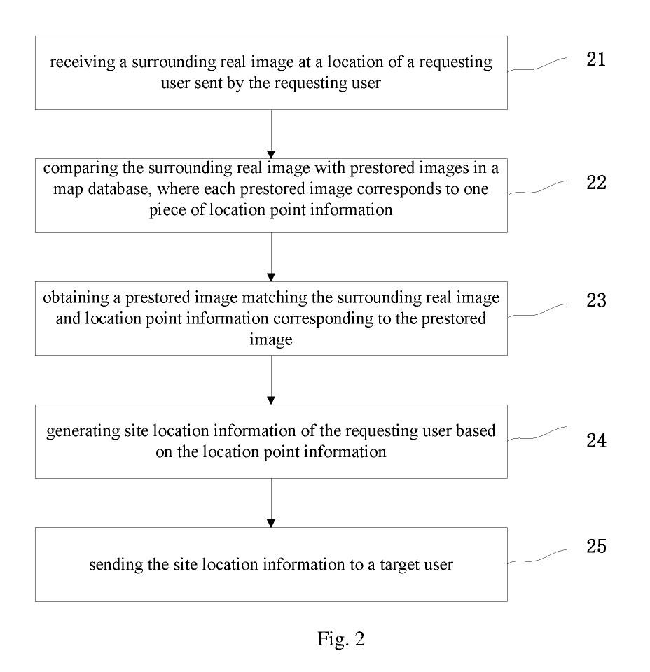

To realize accurate positioning for two or more users which are close to each other, the present disclosure provides a positioning method, which may be applied to a positioning server. As shown in FIG. 2, the positioning method includes the following steps S21 to S25.

In step S21, a surrounding real image at a location of a requesting user sent by the requesting user is received.

The requesting user is usually a user of a mobile terminal. The mobile terminal may be a cellphone, a pad or the like and includes a camera which can capture surrounding real images.

In step S22, the surrounding real image is compared with prestored images in a map database. Each prestored image corresponds to one piece of location point information.

The map database stores therein map information and the prestored images. Each prestored image may be a pre-captured real image of a predetermined location and corresponds to one piece of location point information.

For example, the prestored image may be an image including information of a building such as a mansion, a flyover and other landmark building, and the location point information is orientation information of the building in the prestored image.

In a case that the prestored image is an image including information of a building, real images at each side of the building may be pre-captured to obtain contents shown in the following chart:

| real images of a certain building | location point information |
|---|---|
| real image at a first side | eastern side |
| real image at a second side | southern side |
| real image at a third side | western side |
| real image at a forth side | northern side |

A positioning server prestores the above contents in the map database, and further stores geographical location information of the building in practical application.

In step S23, a prestored image matching the surrounding real image and location point information corresponding to the prestored image are obtained.

In step S24, site location information of the requesting user is generated based on the location point information.

In a case that the location point information is orientation information of the building in the prestored image, the site location information is information of a location of the user with respect to the building generated based on the orientation information of the building.

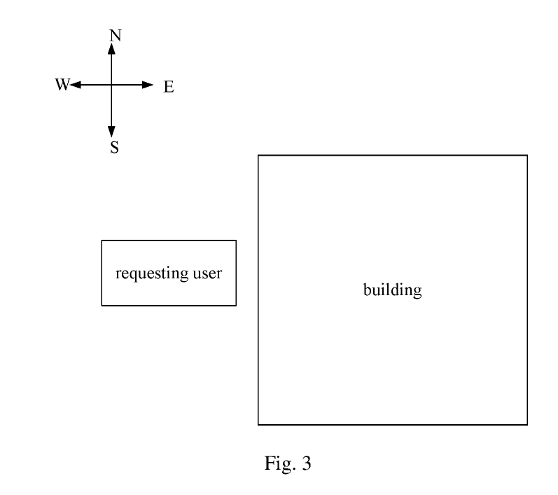

The site location information may be implemented as text information such as “the requesting user is right at the western side of the international trade mansion”, or may be implemented as image information shown in FIG. 3.

In step 25, the site location information is sent to a target user.

The target user may be the requesting user, and in this case, after receiving its site location information, the requesting user may send its site location information to other user via message or in other ways, such that the other user can quickly find the requesting user.

Alternatively, the target user may be other user, and in this case, the positioning server directly sends the site location information of the requesting user to other user and the other user can quickly find the requesting user. Apparently, in the case that the target user is the other user, the requesting user further needs to send an identification, e.g., a cellphone number, of the other user to the positioning server. The identification of the other user may be sent simultaneously while sending the surrounding real image, or may be sent separately.

There may be only one of the other user, or may be two or more other users.

According to the embodiment of the present disclosure, the positioning server prestores an image of a predetermined location and location point information of the predetermined location in the image. In response to reception of the surrounding real image captured by the requesting user in real time, the positioning server obtains a prestored image matching the surrounding real image and location point information corresponding to the prestored image, thereby determining the location of the requesting user. The positioning server sends the location information of the requesting user to the target user, e.g., another user, thereby realizing accurate positioning for two or more users which are close to each other.

In a case that a large number of prestored images are stored in the map database, it is time-consuming to compare the surrounding real image sent from the requesting user with each of the prestored images. In addition, the accuracy of matching is not easy to be ensured, for example, matching turns much more difficult in a case that buildings in many prestored images are similar.

To solve the above problem, in some embodiments of the present disclosure, the requesting user may sends geographical location information (which is usually longitude and latitude information) of a location of the requesting user to the positioning server. Specifically, a mobile terminal corresponding to the requesting user performs positioning with GPS, Beidou navigation system, or applications like navigation map, and then transmits the geographical location information obtained through positioning to the positioning server.

In this case, the step S22 of comparing the surrounding real image with prestored images in the map database may specifically include: step S221, obtaining, from the map database, a prestored image corresponding to the geographical location information; and step S222, comparing the surrounding real image with the prestored image corresponding to the geographical location information.

According to the embodiment, during image matching, only the prestored image corresponding to the geographical location information of the requesting user is obtained, and the surrounding real image sent by the requesting user is compared with the obtained prestored image, thereby greatly reducing the number of prestored images to be compared and improving efficiency and accuracy of matching.

According to some embodiments of the present disclosure, the site location information may include location information of only one user (the requesting user), or may include location information of two or more users (requesting users), such that two or more users which are close to each other may determine locations of each other accurately, which is illustrated with examples in the following.

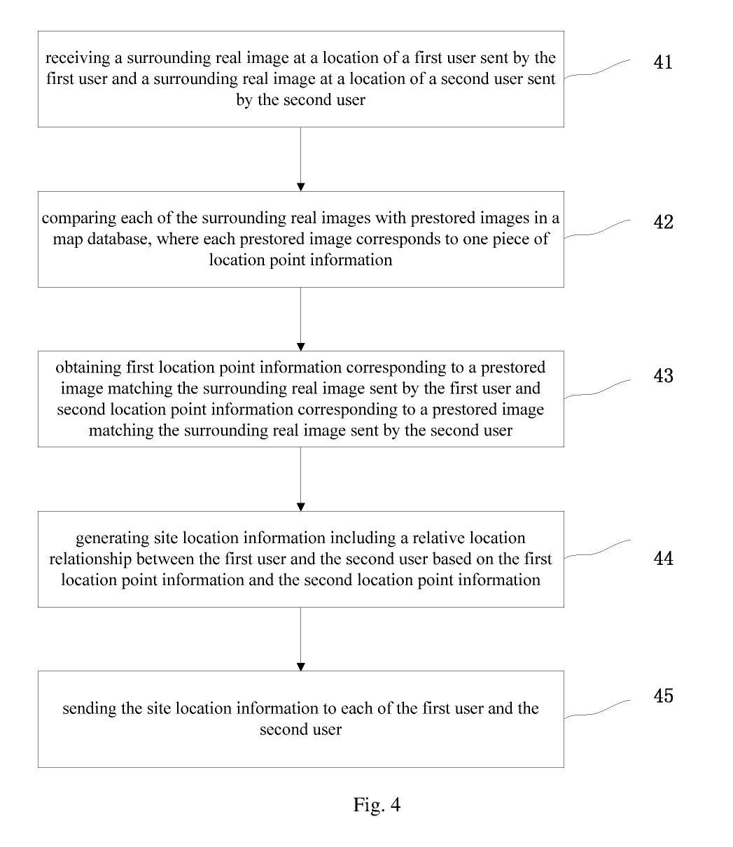

The present disclosure further provides a positioning method applicable to a positioning server. As shown in FIG. 4, the positioning method includes the following steps S41 to S45.

In step S41, a surrounding real image at a location of a first user sent by the first user and a surrounding real image at a location of a second user sent by the second user are received. The first user and the second user are requesting users.

In step S42, each of the surrounding real images is compared with prestored images in a map database. Each prestored image corresponds to one piece of location point information.

In step S43, first location point information corresponding to a prestored image matching the surrounding real image sent by the first user and second location point information corresponding to a prestored image matching the surrounding real image sent by the second user are obtained.

In step S44, site location information including a relative location relationship between the first user and the second user is generated based on the first location point information and the second location point information.

In step S45, the site location information is send to each of the first user and the second user.

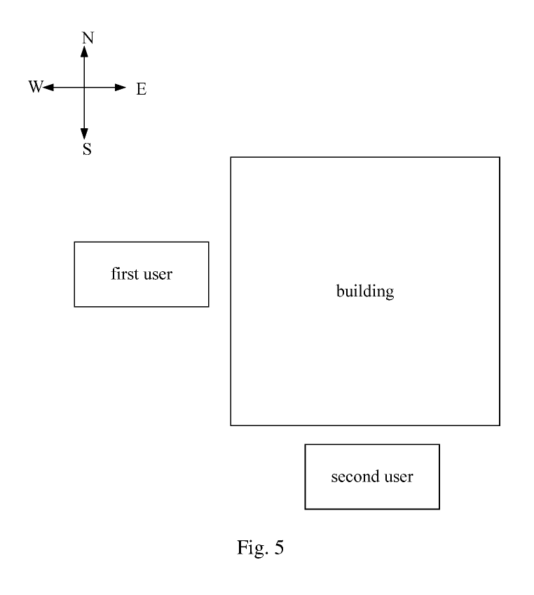

The site location information may be implemented as text information such as “the first user is right at the western side of the international trade mansion and the second user is at the south-eastern side of the international trade mansion”, or may be implemented as image information including the relative location relationship between the first user and the second user, as shown in FIG. 5.

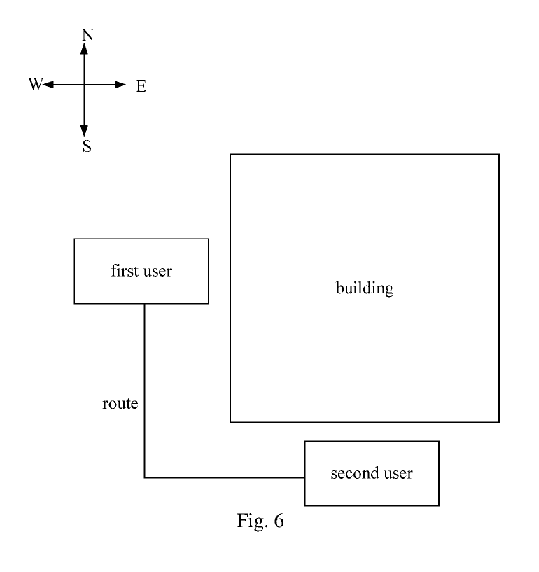

Optionally, as shown in FIG. 6, the site location information includes information of a route between locations of the first user and the second user.

Optionally in the above embodiments, the requesting user may capture two or more surrounding real images and send them to the positioning server, such that the positioning server can determine the location of the requesting user more accurately.

According to some embodiments of the present disclosure, information of the prestored images in the positioning server may be incomplete. In case of failure in finding a prestored image matching the surrounding real image sent by the requesting user in a local map database, map databases in other servers can be inquired.

That is to say, the map database mentioned in the embodiments includes a local map database and map databases in other servers. The step of comparing the surrounding real image with prestored images in the map database includes: comparing the surrounding real image with prestored images in the local map database; and in response to failure in finding a prestored image matching the surrounding real image in the local map database, inquiring the map databases in other servers through network to determine whether any of the map databases stores a prestored image matching the surrounding real image.

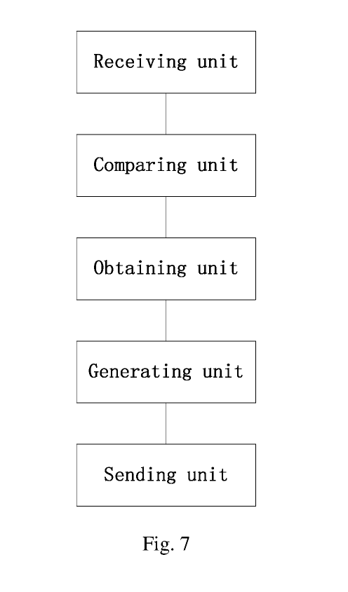

A positioning server is provided according to at least one embodiment of the present disclosure. As shown in FIG. 7, the positioning server includes: a receiving unit used to receive a surrounding real image at a location of a requesting user sent by the requesting user; a comparing unit used to compare the surrounding real image with prestored images in a map database, where each prestored image corresponds to one piece of location point information; an obtaining unit used to obtain a prestored image matching the surrounding real image and location point information corresponding to the prestored image; a generating unit used to generate site location information of the requesting user based on the location point information; and a sending unit used to send the site location information to a target user.

Optionally, the receiving unit is further used to, receive geographical location information of a location of the requesting user sent by the requesting user, the comparing unit is further used to, obtain, from the map database, a prestored image corresponding to the geographical location information, and compare the surrounding real image with the prestored image corresponding to the geographical location information.

Optionally, the requesting user includes a first user and a second user. The generating unit is further used to, obtain first location point information corresponding to a prestored image matching the surrounding real image sent by the first user and second location point information corresponding to a prestored image matching the surrounding real image sent by the second user, and generate site location information including a relative location relationship between the first user and the second user based on the first location point information and the second location point information.

Optional implementations of the present disclosure are described above. It should be noted that, the ordinary skilled in the art can make various modifications and polishment without departing from the principle of the present disclosure, and all those modifications and polishment fall within the scope of protection of the present disclosure.

What is claimed is:

1. A positioning method, comprising:
receiving a surrounding real image at a location of a requesting user sent by the requesting user;
comparing the surrounding real image with prestored images in a map database, wherein each prestored image corresponds to one piece of location point information;
obtaining a prestored image matching the surrounding real image and location point information corresponding to the prestored image;
generating site location information of the requesting user based on the obtained location point information; and
sending the site location information to a target user.

2. The positioning method according to claim 1, further comprising:
receiving geographical location information of the location of the requesting user sent by the requesting user;
wherein the step of comparing the surrounding real image with prestored images in a map database comprises:
obtaining, from the map database, a prestored image corresponding to the geographical location information; and
comparing the surrounding real image with the prestored image corresponding to the geographical location information.

3. The positioning method according to claim 1, wherein the requesting user comprises a first user and a second user;
wherein the step of obtaining a prestored image matching the surrounding real image and location point information corresponding to the prestored image comprises:
obtaining first location point information corresponding to a prestored image matching the surrounding real image sent by the first user and second location point information corresponding to a prestored image matching the surrounding real image sent by the second user; and
wherein the step of generating site location information of the requesting user based on the obtained location point information comprises:
generating site location information including a relative location relationship between the first user and the second user based on the first location point information and the second location point information.

4. The positioning method according to claim 3, wherein the site location information comprises information of a route between locations of the first user and the second user.

5. The positioning method according to claim 1, wherein the surrounding real image and each prestored image both comprise information of a building.

6. The positioning method according to claim 1, wherein the location point information comprises orientation information of a building in the prestored image.

7. The positioning method according to claim 6, wherein the site location information comprises information of a location of the user with respect to the building generated based on the orientation information of the building.

8. The positioning method according to claim 1, wherein the map database comprises a local map database and map databases in other servers; and
the step of comparing the surrounding real image with prestored images in a map database comprises:
comparing the surrounding real image with prestored images in the local map database; and
in response to failure in finding a prestored image matching the surrounding real image in the local map database, inquiring the map databases in other servers through network to determine whether any of the map databases stores a prestored image matching the surrounding real image.

9. The positioning method according to claim 1, wherein the target user is the requesting user.

10. The positioning method according to claim 1, wherein the target user is a user other than the requesting user; and before the step of sending the site location information to a target user, the positioning method comprises: receiving information about the target user sent by the requesting user.

11. A positioning server, comprising:
a receiving unit, configured to receive a surrounding real image at a location of a requesting user sent by the requesting user;
a comparing unit, configured to compare the surrounding real image with prestored images in a map database, wherein each prestored image corresponds to one piece of location point information;
an obtaining unit, configured to obtain a prestored image matching the surrounding real image and location point information corresponding to the prestored image;
a generating unit, configured to generate site location information of the requesting user based on the obtained location point information; and
a sending unit, configured to send the site location information to a target user.

12. The positioning server according to claim 11, wherein
the receiving unit is further configured to receive geographical location information of the location of the requesting user sent by the requesting user; and
the comparing unit is further configured to:
obtain, from the map database, a prestored image corresponding to the geographical location information; and
compare the surrounding real image with the prestored image corresponding to the geographical location information.

13. The positioning server according to claim 11, wherein the requesting user comprises a first user and a second user; and
the generating unit is further configured to: obtain first location point information corresponding to a prestored image matching the surrounding real image sent by the first user and second location point information corresponding to a prestored image matching the surrounding real image sent by the second user; and generate site location information including a relative location relationship between the first user and the second user based on the first location point information and the second location point information.

14. The positioning server according to claim 13, wherein the site location information comprises information of a route between locations of the first user and the second user.

15. The positioning server according to claim 11, wherein the surrounding real image and each prestored image both comprise information of a building.

16. The positioning server according to claim 11, wherein the location point information comprises orientation information of a building in the prestored image.

17. The positioning server according to claim 16, wherein the site location information comprises information of a location of the user with respect to the building generated based on the orientation information of the building.

18. The positioning server according to claim 11, wherein the map database comprises a local map database and map databases in other servers; and
the comparing unit is further configured to: compare the surrounding real image with prestored images in the local map database; and in response to failure in finding a prestored image matching the surrounding real image in the local map database, inquire the map databases in other servers through network to determine whether any of the map databases stores a prestored image matching the surrounding real image.

19. The positioning server according to claim 11, wherein the target user is the requesting user.

20. The positioning server according to claim 11, wherein the target user is a user other than the requesting user; and the receiving unit is further configured to receive information about the target user sent by the requesting user.
